(19) United States
(12) Patent Application Publication
(10) Pub. No.: US 2006/0101619 A1
(43) Pub. Date: May 18, 2006

(54) Multi-functional hinge

(76) Inventor: Wen-Hao Tai, Hsinchuang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/986,112

(22) Filed: Nov. 12, 2004

(51) Int. Cl. E05D 3/06

(52) U.S. Cl. 16/366

(57) ABSTRACT

A multi-functional hinge includes a lifting frame, left and right fixing seats having mounting shafts extended through front left and front right through holes on the lifting frame, a left pivoted arm having a shaft extended through a rear left through hole on the lifting frame, a pivot shaft extended through a right pivoted arm and a rear right through hole on the lifting frame, and a link connected at two ends to eccentric butts separately provided at outer ends of the right fixing seat and the pivot shaft. An article, such as an LCD screen, a work platform or a rack, mounted on the left and right pivoted arms could be pivotally turned or swung to different viewing inclinations. And, the lifting frame could be pivotally turned about the fixing seats to different lifted positions without changing the desired viewing inclination set for the article.

### FIELD OF THE INVENTION

The present invention relates to a multi-functional hinge, and more particularly to a hinge that allows an article, such as an LCD screen, a work platform or a rack, mounted thereto to be lifted to different heights without changing a desired viewing inclination set for the article.

### BACKGROUND OF THE INVENTION

Generally, an LCD screen is connected to a base using a hinge, so as to be pivotally turned to an inclination suitable for viewing. However, the conventional hinge only allows the LCD screen to be pivotally turned to a fixed viewing inclination but not allows adjustment of the LCD screen to a vertical position that is suitable for a relatively tall or short user to view the screen comfortably. Therefore, it is desirable to develop a hinge that allows the LCD screen mounted thereto to be adjusted to any height to meet the requirement of different users.

### SUMMARY OF THE INVENTION

A primary object of the present invention is to provide a multi-functional hinge that allows an article mounted thereto to be lifted to different heights without changing a desired viewing inclination set for the article or causing undesired swing of the article.

To achieve the above and other objects, the multi-functional hinge according to the present invention mainly includes a lifting frame, left and right fixing seats, left and right pivoted arms, a pivot shaft, and a link. The lifting frame is provided at front and rear corners with mounting holes for the fixing seats and the pivoted arms to mount thereto. The left and right fixing seats are connected to the lifting frame by way of extending respective mounting shafts of the left and right fixing seats through front left and front right through holes on the lifting frame, and then locking the left and right fixing seats to the lifting frame with nuts. The left pivoted arm is connected to the lifting frame by way of extending a shaft of the left pivoted arm into a rear left through hole on the lifting frame and a pivot hole of the left pivoted arm, and then locking the left pivoted arm to the lifting frame with a nut. The right pivoted arm is connected to the lifting frame by way of extending the pivot shaft through a rear right through holes on the lifting frame and a pivot hole on the right pivoted arm, and then locking the right pivoted arm to the lifting frame with a nut. The link is connected at two ends to eccentric butts separately provided at outer ends of the right fixing seat and the pivot shaft. Whereby when an article, such as an LCD screen, a work platform, a rack or the like, is mounted on the left and right pivoted arms, the screen could be pivotally turned or swung to a desired viewing inclination. With the pivot shaft stuck in the pivot hole of the right pivoted arm and located in place by the link, the lifting frame could be pivotally turned about the two fixing seats to any lifted position with the article being kept at the same desired viewing inclination without the risk of swinging forward and backward about the left and right pivoted arms.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an assembled perspective view of a multi-functional hinge according to the present invention;

FIG. 2 is an exploded perspective view of FIG. 1;

FIG. 3 is a perspective view of the multi-functional hinge of the present invention in a first position thereof;

FIG. 4 is a perspective view of the multi-functional hinge of the present invention in a second position thereof;

FIG. 5 is a perspective view of the multi-functional hinge of the present invention in a third position thereof;

FIGS. 6, 7, and 8 are side views showing the operation of the multi-functional hinge of the present invention;

FIG. 9 shows a right pivoted arm and a pivot shaft included in the present invention;

FIGS. 10 to 14 are schematic side views showing the relation between the right pivoted arm and the pivot shaft of FIG. 9;

FIG. 15 is an exploded perspective view of a multi-functional hinge according to another embodiment of the present invention; and

FIG. 16 is an assembled perspective view of FIG. 15.

### DETAILED DESCRIPTION OF THE PREFERRED EMBODIMENTS

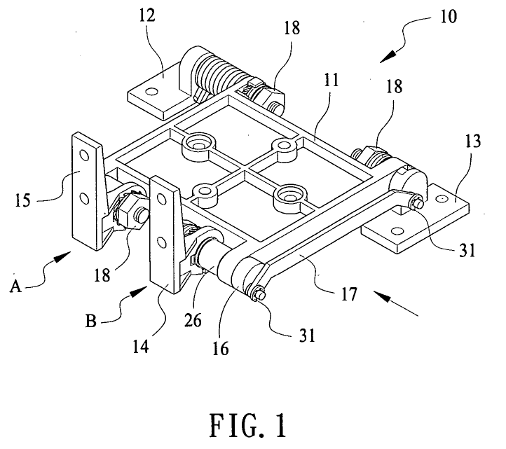

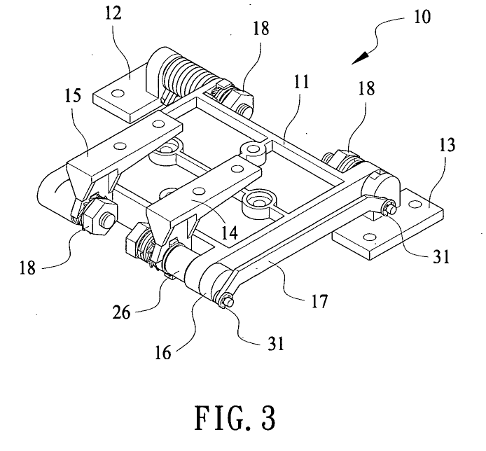

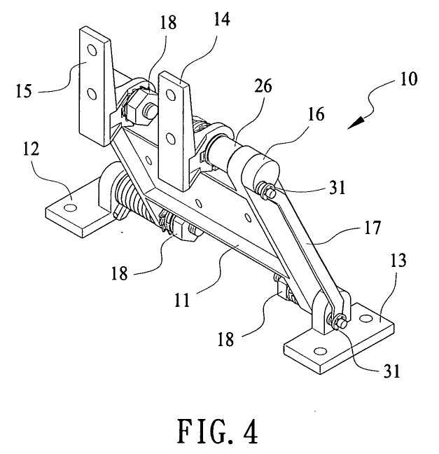

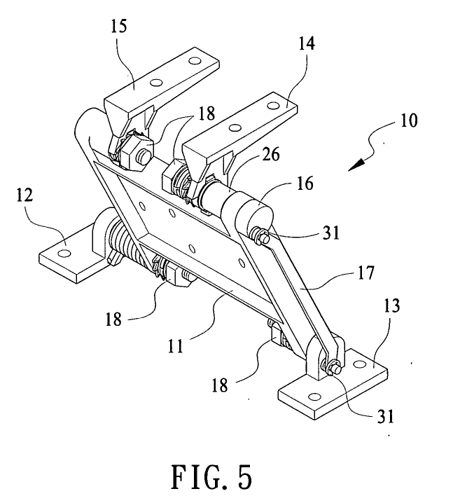

Please refer to FIGS. 1 to 5, in which a multi-functional hinge 10 according to an embodiment of the present invention is shown. As shown, the hinge 10 mainly includes a lifting frame 11, a left fixing seat 12, a right fixing seat 13, a left pivoted arm 14, a right pivoted arm 15, a pivot shaft 16, and a link 17.

The lifting frame 11 is provided at front and rear corners with four through holes 111 for the fixing seats 12, 13 and the pivoted arms 14, 15 to mount thereto.

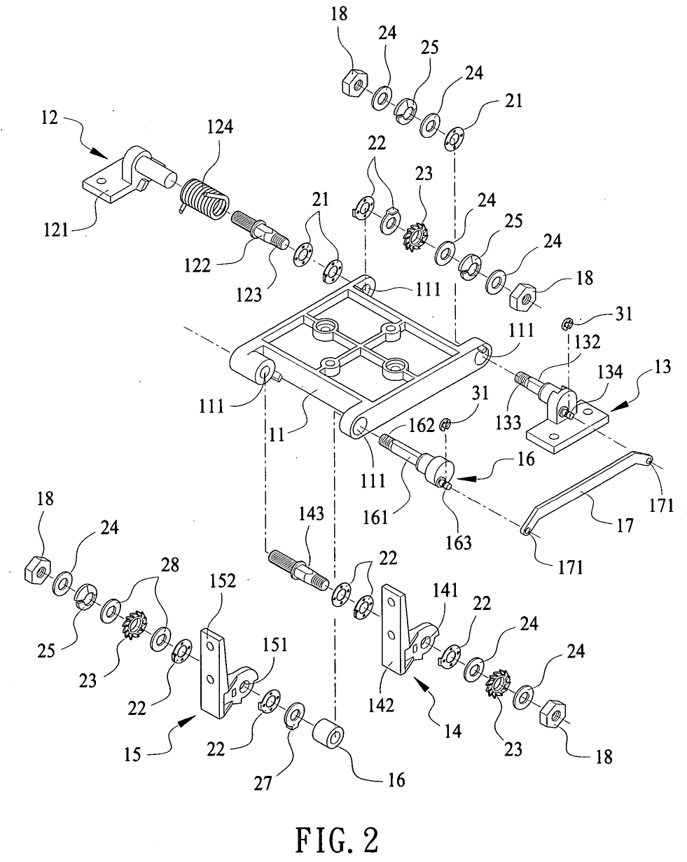

As can be most clearly seen from FIG. 2, the left and the right fixing seat 12, 13 respectively include a mounting plate 121, 131 and a mounting shaft 122, 132 projected from an inner end of the mounting plate 121, 131. The mounting shafts 122, 132 are provided at respective inner end with a locking section 123, 133.

The left pivoted arm 14 is provided at a front end with a left pivot hole 141, through which a shaft 143 of the left pivoted arm 14 is extended to rotatably connect the left pivoted arm 14 to a rear left one of the through holes 111 of the lifting frame 11, and at a rear end with a vertically upward extended left mounting section 142 for fixedly connecting to an article (not shown), such as a liquid crystal display (LCD) screen, a work platform, a rack, or the like.

The right pivoted arm 15 is provided at a front end with a right pivot hole 151, through which the pivot shaft 16 is extended to rotatably connect the right pivoted arm 15 to a rear right one of the through holes 111 of the lifting frame 11, and at a rear end with a vertically upward extended right mounting section 152 for fixedly connecting to the article. The right pivot hole 151 may be a substantially figure-8-shaped hole or a round hole.

The pivot shaft 16 includes an inward extended rectangle-sectioned shaft body 161, an inner end of which is a threaded locking section 162. When the pivot shaft 16 is rotated, the shaft body 161 extended through the right pivot hole 151 on the right pivoted arm 15 is caused to firmly stick in the hole 151 at different positions.

The link 17 is mounted to the right outer side of the lifting frame 11 by separately connecting two mounting holes 171 provided at front and rear ends of the link 17 to two eccentric butts 134, 163 formed on outer ends of the right fixing seat 13 and the pivot shaft 16, respectively.

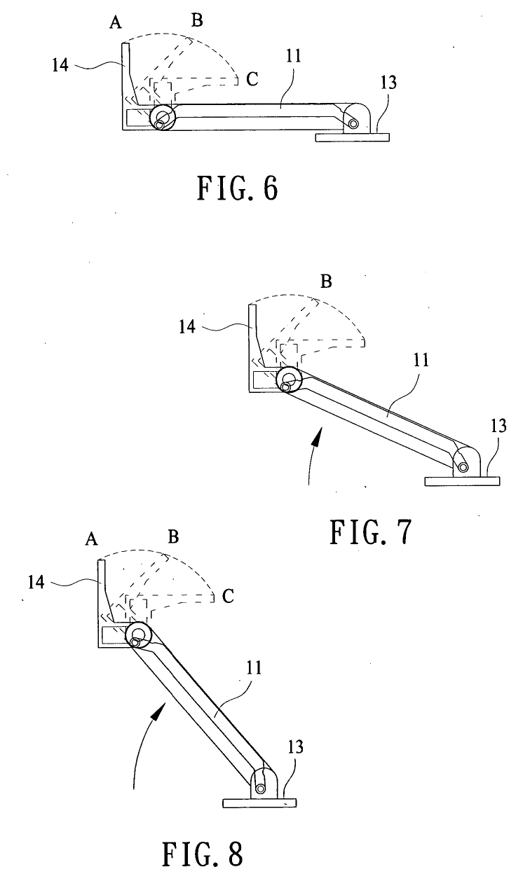

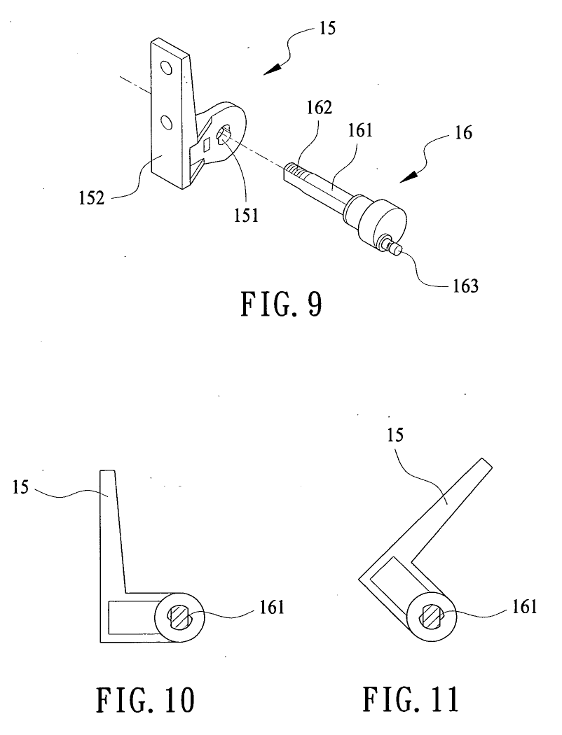

Please refer to FIGS. 6 to 14. The left and the right fixing seat 12, 13 are connected to the front left and front right corners of the lifting frame 11 by way of extending the mounting shafts 122, 132 of the left and the right fixing seat 12, 13 through corresponding through holes 111, and then screwing two nuts 18 to the locking sections 123, 133 of the mounting shafts 122, 132, respectively, to lock the left and the right fixing seat 12, 13 to the lifting frame 11. The left pivoted arm 14 is connected to the rear left corner of the lifting frame 11 by way of extending an outer end of the shaft 143 of the left pivoted arm 14 into the corresponding rear left through hole 111 on the lifting frame 11 and an inner end of the shaft 143 through the left pivot hole 141 of the left pivoted arm 14, and then screwing a nut 18 to the inner end of the shaft 143 to lock the left pivoted arm to the lifting frame 11. The right pivoted arm 15 is connected to the lifting frame 11 by way of extending the shaft body 161 of the pivot shaft 16 through the corresponding rear right through hole 111 on the lifting frame 11 and the pivot hole 151 of the right pivoted arm 15, and then screwing a nut 18 to the locking section 162 of the pivot shaft 16 to lock the right pivoted arm 15 to the lifting frame 11. The link 17 is connected at two ends to the eccentric butts 134, 163 on the outer ends of the right fixing seat 13 and the pivot shaft 16, respectively. With these arrangements, the article mounted on the left and the right pivoted arm 14, 15 could be pivotally turned or swung to a desired viewing inclination. With the rectangle-sectioned shaft body 161 of the pivot shaft 16 stuck and located in the figure-8-shaped or round pivot hole 151 of the right pivoted arm 15, and the link 17 that locates the pivot shaft 16 in place, the lifting frame 11 could be pivotally turned about the left and right fixing seats 12, 13 to any lifted position with the article being kept at the same viewing inclination without the risk of swinging forward and backward about the left and the right pivoted arms 14, 15.

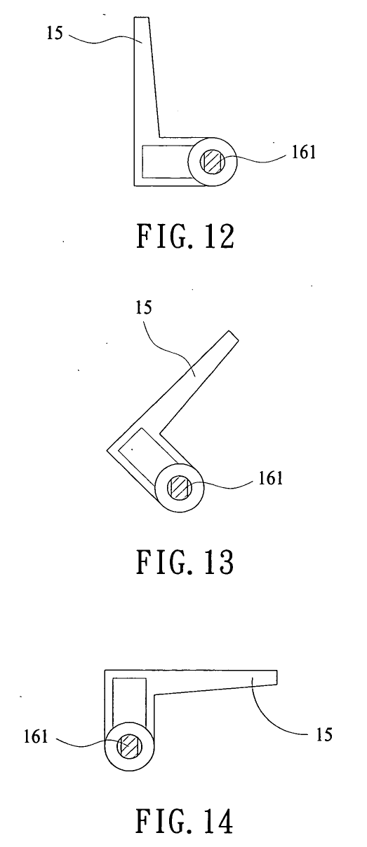

Please particularly refer to FIGS. 10 to 14. The right pivoted arm 15 could be turned or swung about the shaft body 161 of the pivot shaft 16 to any desired inclination and be held thereto. And, when the right pivoted arm 15 is turned or swung about the pivot shaft 16, the lifting frame 11 could be simultaneously lifted or upward turned about the left and the right fixing seat 12, 13. With the lifting frame 11 and the pivoted arms 14, 15 that could be freely pivotally turned or swung, the article mounted to the left and the right pivoted arm 14, 15 could be adjusted to any desired position, as shown in FIGS. 6, 7, and 8.

Please refer back to FIGS. 1 to 5, particularly to FIG. 2. A pair of oil rings 21, a pair of lugged rings 22, an externally toothed elastic washer 23, a pair of washers 24, and an elastic washer 25 are positioned between the left fixing seat 12 and the corresponding nut 18, so that the left fixing seat 12 is prevented from rotating along with the lifting frame 11 when the latter is turned relative to the left fixing seat 12.

An elastic element 124 is put around the mounting shaft 122 of the left fixing seat 12 to provide an elastic force for the lifting frame 11 to restore from a pivotally turned position.

An oil ring 21, a pair of washers 24, and an elastic washer 25 are positioned between the right fixing seat 13 and the corresponding nut 18, so that the right fixing seat 13 is prevented from rotating along with the lifting frame 11 when the latter is turned relative to the right fixing seat 13.

A pair of lugged rings 22 is mounted between the lifting frame 11 and the left pivoted arm 14, and a lugged ring 22, a pair of washers 24, and an externally toothed elastic washer 23 are positioned between the left pivoted arm 14 and the corresponding nut 18, so that the lifting frame 11 is prevented from rotating along with the left pivoted arm 14 when the latter is turned relative to the lifting frame 11.

A sleeve 26, a stopper 27, and a lugged ring 22 are positioned between the lifting frame 11 and the right pivoted arm 15, and a lugged ring 22, a pair of locating rings 28, an externally toothed elastic washer 23, an elastic washer 25, and a washer 24 are positioned between the right pivoted arm 15 and the corresponding nut 18, so that the lifting frame 11 is prevented from rotating along with the right pivoted arm 15 when the latter is turned relative to the lifting frame 11.

The link 17 is firmly connected to the right fixing seat 13 and the pivot shaft 16 without the risk of easily separating therefrom by way of engaging the mounting holes 171 at two ends of the link 17 with the eccentric butts 134, 163 at outer ends of the right fixing seat 13 and the pivot shaft 16, respectively, and clamping two retaining c-rings 31 on the eccentric butts 134, 163.

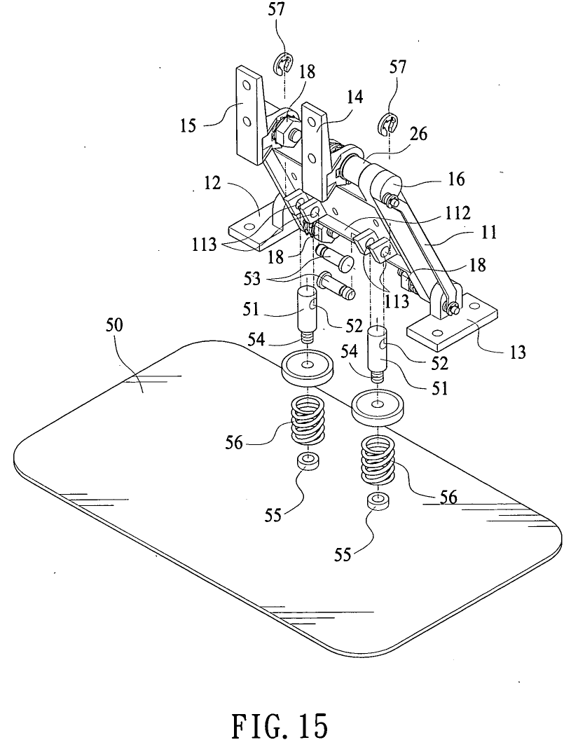

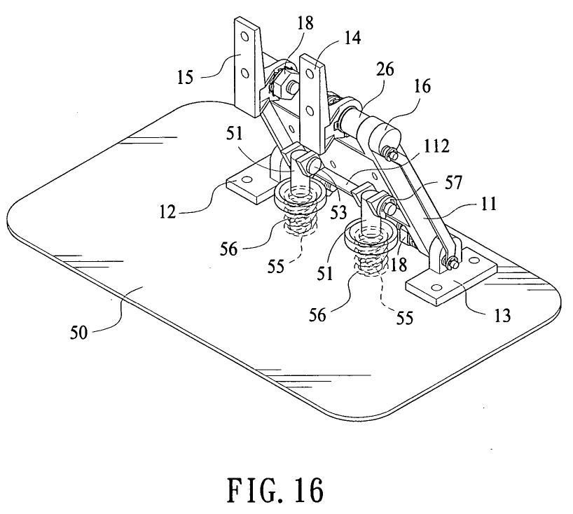

FIGS. 15 and 16 shows another embodiment of the present invention. In this embodiment, the lifting frame 11 is fixedly mounted at two front corners on an object, such as a desktop 50, and provided at a middle area with a transverse link 112. The link 112 is provided near two lateral ends with two pairs of through holes 113. The desktop 50 is provided on a top with a pair of vertical posts 51, each of which is provided near an upper end with a transverse through hole 52. Two fixing shafts 53 are separately outward extended through the transverse through holes 52 on the vertical posts 51 and the two pairs of through holes 113 on the link 112, and two retaining c-rings 57 are separately clamped to outer ends of the two fixing shafts 53, so that the vertical posts 51 are pivotally turnably connected to the link 112. Moreover, each of the vertical posts 51 is provided at a lower end with a threaded locking section 54. The vertical posts 51 are movably fixed to two locating holes 55 correspondingly provided on the desktop 50 by way of downward extending the locking sections 54 of the vertical posts 51 through the locating holes 55 and screwing two nuts to the locking sections 54 below the locating holes 55. In this manner, the lifting frame 11 is fixed to the desktop 50 and could be pivotally turned or swung relative to the vertical posts 51.

In the embodiment shown in FIGS. 15 and 16, an elastic element 56, such as a spring, is put on each of the vertical posts 51 to provide the lifting frame 11 with an elastic restoring force.

With the above arrangements, a relatively tall or short user may freely turn or swing the article mounted on the hinge to a suitable viewing inclination, and lift the lifting frame 11 to adjust a vertical position of the article relative to, for example, a desktop, so that the article could be quickly and conveniently adjusted in its height and inclination to locate at a position more suitable for viewing.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A multi-functional hinge, comprising:
a lifting frame having through holes provided at front and rear corners;
a left fixing seat including a mounting plate and a mounting shaft sideward projected from an inner end of said mounting plate, and said mounting shaft being provided at an inner end with a threaded locking section;
a right fixing seat including a mounting plate and a mounting shaft sideward projected from an inner end of said mounting plate, and said mounting shaft being provided at an inner end with a threaded locking section;
a left pivoted arm being provided at a front end with a left pivot hole, through which a shaft of said left pivoted arm is extended to rotatably connect said left pivoted arm to a rear left one of said through holes on said lifting frame, and at a rear end with a vertically upward extended left mounting section for fixedly connecting to an article;
a right pivoted arm being provided at a front end with a right pivot hole, through which a pivot shaft is extended to rotatably connect said right pivoted arm to a rear right one of said through holes on said lifting frame, and at a rear end with a vertically upward extended right mounting section for fixedly connecting to said article;
said pivot shaft including an inward extended rectangle-sectioned shaft body, an inner end of which is a threaded locking section, said shaft body being extended through and engaged with said right pivot hole on said right pivoted arm, such that said shaft body of said pivot shaft is stuck in said right pivot hole at different positions when said article is pivotally turned or swung; and
a link mounted to a right outer side of said lifting frame by separately connecting two mounting holes provided at front and rear ends of said link to two eccentric butts formed on outer ends of said right fixing seat and said pivot shaft;
said left and said right fixing seat being respectively connected to a front left and a front right corner of said lifting frame byway of extending said mounting shafts of said left and right fixing seats through said front left and front right through holes on said lifting frame, and then screwing two nuts to said locking sections of said mounting shafts to lock said left and right fixing seats to said lifting frame;
said left pivoted arm being connected to a rear left corner of said lifting frame by way of extending an outer end of said shaft of said left pivoted arm into said rear left through hole on said lifting frame and an inner end of said shaft through said left pivot hole of said left pivoted arm, and then screwing a nut to the inner end of said shaft of said left pivoted arm to lock said left pivoted arm to said lifting frame;
said right pivoted arm being connected to said lifting frame by way of extending said shaft body of said pivot shaft through said rear right through hole on said lifting frame and said pivot hole on said right pivoted arm, and then screwing a nut to said locking section of said pivot shaft to lock said right pivoted arm to said lifting frame; and
whereby when said article is mounted on said left and said right pivoted arm, said article could be pivotally turned or swung to a desired viewing inclination; and wherein when said rectangle-sectioned shaft body of said pivot shaft is stuck to locate in said right pivot hole of said right pivoted arm, and said link locates said pivot shaft in place, said lifting frame could be pivotally turned about said left and right fixing seats to any lifted position with said article being kept at the same desired viewing inclination without the risk of swinging forward and backward about said left and said right pivoted arm.

2. The multi-functional hinge as claimed in claim 1, wherein said articled mounted to said hinge is a liquid crystal display (LCD) screen.

3. The multi-functional hinge as claimed in claim 1, further comprising a pair of oil rings, a pair of lugged rings, an externally toothed elastic washer, a pair of washers, and an elastic washer positioned between said left fixing seat and the corresponding nut, so that said left fixing seat is prevented from rotating along with said lifting frame when said lifting frame is turned relative to said left fixing seat.

4. The multi-functional hinge as claimed in claim 3, further comprising an elastic element put on said mounting shaft of said left fixing seat to provide an elastic force for said lifting frame to restore from a pivotally turned position.

5. The multi-functional hinge as claimed in claim 1, further comprising an oil ring, a pair of washers, and an elastic washer positioned between said right fixing seat and the corresponding nut, so that said right fixing seat is prevented from rotating along with said lifting frame when said lifting frame is turned relative to said right fixing seat.

6. The multi-functional hinge as claimed in claim 1, further comprising a pair of lugged rings mounted between said lifting frame and said left pivoted arm; and a lugged ring, a pair of washers, and an externally toothed elastic washer positioned between said left pivoted arm and the corresponding nut, so that said lifting frame is prevented from rotating along with said left pivoted arm when said left pivoted arm is turned relative to said lifting frame.

7. The multi-functional hinge as claimed in claim 1, further comprising a sleeve, a stopper, and a lugged ring positioned between said lifting frame and said right pivoted arm; and a lugged ring, a pair of locating rings, an externally toothed elastic washer, an elastic washer, and a washer positioned between said right pivoted arm and the corresponding nut, so that said lifting frame is prevented from rotating along with said right pivoted arm when said right pivoted arm is turned relative to said lifting frame.

8. The multi-functional hinge as claimed in claim 1, wherein said link is firmly connected at two ends to said eccentric butts on said right fixing seat and said pivot shaft without the risk of easily separating therefrom by way of mounting two retaining c-rings to outer ends of said two eccentric butts.

9. The multi-functional hinge as claimed in claim 1, wherein said right pivot hole is selected from the group consisting of a substantially figure-8-shaped hole and a round hole.

10. The multi-functional hinge as claimed in claim 1, wherein said lifting frame is fixedly mounted at two front corners on an object, and provided at a middle area with a transverse link; said link being provided near two lateral ends with two pairs of through holes; said object being provided on a top with a pair of vertical posts, each of which is provided near an upper end with a transverse through hole; two fixing shafts being separately outward extended through said transverse through holes on said vertical posts and the two pairs of through holes on said transverse link; and two retaining c-rings being separately clamped to outer ends of said two fixing shafts, so that said vertical posts are pivotally turnably connected at upper ends to said transverse link; and each of said vertical posts being provided at a lower end with a threaded locking section; whereby said vertical posts are movably fixed to two locating holes correspondingly provided on said object by way of downward extending said locking sections of said vertical posts through said locating holes and screwing two nuts to said locking sections below said locating holes, allowing said lifting frame to be fixedly mounted on said object and be pivotally turned or swung relative to said vertical posts.

11. The multi-functional hinge as claimed in claim 10, wherein said object is a desktop.

12. The multi-functional hinge as claimed in claim 10, wherein each of said vertical posts has a spring put thereon to provide said lifting frame with an elastic restoring force.
